(19) United States
(12) Patent Application Publication
(10) Pub. No.: US 2008/0077851 A1
(43) Pub. Date: Mar. 27, 2008

(54) METHOD AND APPARATUS FOR INSERTING JSR 168 PORTLET CONTENT INTO A J2EE JAVA SERVER PAGE

(75) Inventors: Stephan Hesmer, Holzgerlingen (DE); Scott D. Johnson, Durham, NC (US); Todd E. Kaplinger, Raleigh, NC (US); Christopher C. Mitchell, Raleigh, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/535,195

(22) Filed: Sep. 26, 2006

(51) Int. Cl. G06F 17/00

(52) U.S. Cl. 715/234; 715/205

(57) ABSTRACT

Incorporating a plurality of tags into a Java server page (JSP) or JSP-compliant page fragment to insert portlet content from a portlet onto a page without using an enterprise portal application. Each of the plurality of tags conforms to Java 2 Platform Enterprise Edition (J2EE) and JSP. The portlet content conforms to Java Specification Request (JSR) 168. The tags specify a rendering of portlet content in the JSP-compliant page or page fragment such that no change is introduced to the portlet itself. The tags include an initialization tag setting forth a uniform resource locator (URL) prefix, an insertion tag setting forth a first URL, and a state tag setting forth a second URL, wherein the first URL and the second URL may, but need not, be identical.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to portal technology and, more specifically, to a method and an apparatus for inserting JSR 168 portlet content into a J2EE Java server page.

2. Description of Background

A portlet is a component of a web site that provides access to one or more specific information sources or applications, such as news updates, technical support, email programs, or any of a multitude of other possibilities. Portals aggregate content into a single interface, whereas portlets connect users to specific content within that interface. Many portals offer a selection of portlets that the user can select to provide a customized interface. Portals connect to portlets through portlet application programming interfaces (APIs).

Java Specification Request (JSR) 168 provides interoperability among portlets and portals. This specification defines a set of APIs for portlets and addresses standardization for preferences, user information, portlet requests and responses, deployment packaging, and security. More specifically, JSR 168 establishes a standard API for creating portlets, the integration component between applications and portals that enables delivery of an application through a portal. Without this standard, each version of an application has needed its own portlet API, and each of the various portals required that these portlets be specifically tailored for implementation through that portal. This has raised portlet developer time, effort, and cost, with the effect that fewer applications have been made available through fewer portals to the detriment of end users, developers, and portal vendors. By adhering to JSR 168, applications can be delivered through any portal almost immediately.

Java server page (JSP) is a technology for controlling the content or appearance of web pages through the use of servlets, small Java programs that are specified in the web page and execute on a web server to modify the web page before the page is sent to a requesting user. JSP is also referred to as a servlet API. A hypertext markup language (HTML) page that contains a link to a Java servlet is typically assigned a file name suffix of JSP.

Java 2 Platform Enterprise Edition (J2EE) is a Java platform designed for the mainframe-scale computing typical of large enterprises. J2EE simplifies application development and decreases the need for programmer training by creating standardized, reusable modular components. Write Once, Run Anywhere technology is included in J2EE to ensure portability.

Enterprise portal technology has evolved to the point where standards such as JSR 168 are emerging for building portable web content that can be used in a variety of enterprise portal applications. However, standards groups have not yet finalized standards for enterprise portal applications and page layout/aggregation mechanisms. J2EE applications include standards for building web applications (servlet and JSP) and is expected to include JSR 168 in the future, thereby standardizing servlets, JSPs and portlet component models. J2EE and existing JSP specifications do not specify how to use JSR 168 portlets within standard J2EE JSP-based web applications in situations where there is not an enterprise portal performing customer page layout. In order to use portlet components, one must also have access to an enterprise portal or a container capable of rendering portlets inside web pages.

At present, user interfaces (UIs) are often utilized from within standard J2EE web applications. Constructing user interfaces based upon JSR 168 technology is precluded in many practical situations because one does not initially require the full set of features that an enterprise portal application provides. However, at some point in the future, the full capabilities of an enterprise portal may be required. If an enterprise portal is now added, problems may occur. All UIs that were utilized from within standard J2EE web applications must now be re-coded for use with the new enterprise portal. This re-coding process is laborious and time-consuming.

### SUMMARY OF THE INVENTION

The shortcomings of the prior art are overcome and additional advantages are provided by incorporating a plurality of tags into a Java server page (JSP) or JSP-compliant page fragment to insert portlet content from a portlet directly onto a page without using an enterprise portal application. Each of the plurality of tags conforms to Java 2 Platform Enterprise Edition (J2EE) and JSP. The tags are used to render portlet content in the JSP or JSP-compliant page fragment such that no change is introduced to the portlet itself. The tags include an initialization tag setting forth a uniform resource locator (URL) prefix, an insertion tag setting forth a first URL, and a state tag setting forth a second URL, wherein the first URL and the second URL may, but need not, be identical.

Further illustrative embodiments invoke a portlet on a JSP-compliant page or page fragment using a standard web container hypertext transfer protocol (HTTP) request. JSR 168 portlet content from the portlet is displayed directly using a web browser, such that an enterprise portal application is not required to display the JSR 168 portlet content.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution wherein a web page renders portlet content, but introduces no change to the portlet itself, thereby permitting the portlet to be used at a later time within an enterprise portal application. In addition, portlet content from a portlet is displayed directly using a web browser, such that an enterprise portal application is not required to display the portlet content.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating a first example of an apparatus for insertion of JSR 168 portlet content into a J2EE Java server page.

FIG. 2 illustrates one example of an HTML page including tags for use with the apparatus of FIG. 1.

FIG. 3 is a block diagram illustrating a second example of an apparatus for insertion of JSR 168 portlet content into J2EE Java server page.

FIG. 4 is a block diagram illustrating one example of providing security features for use with the apparatus of FIG. 3.

FIG. 5 is a block diagram illustrating a first example of an apparatus for processing portlet fragments to provide insertion of JSR 168 portlet content into a J2EE Java server page.

FIG. 6 is a block diagram illustrating a second example of an apparatus for processing portlet fragments to provide insertion of JSR 168 portlet content into J2EE Java server page.

Like reference numerals are used to refer to like elements throughout the drawings. The detailed description explains the preferred embodiments of the invention, together with advantages and features, by way of example with reference to the drawings.

### DETAILED DESCRIPTION OF THE INVENTION

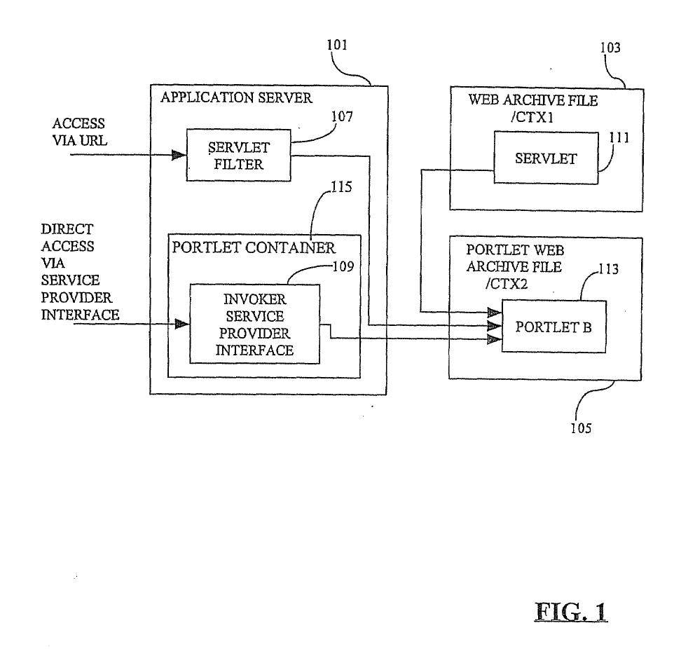

FIG. 1 is a block diagram illustrating a first example of an apparatus for insertion of JSR 168 portlet content into a J2EE Java server page. An application server 101 includes a servlet filter 107 and a portlet container 115. Portlet container 115 includes an invoker service provider interface (SPI) 109. Application server 101 may be accessed via a standard uniform resource locator (URL) received by servlet filter 107, or may also be accessed directly via a service provider interface (SPI) using invoker service provider interface 109. A web archive (WAR) file 103 is provided which includes a servlet 111. WAR file 103 is accessed using a first URL fragment such as /CTX1. A portlet web archive (WAR) file 105 is provided which includes a portlet designated as portlet B 113. Portlet WAR file 105 is accessed using a second URL fragment such as /CTX2.

Portlet B 113 and servlet 111 may be written by software developers, adopted from existing applications, or both. Portlet B 113 may be accessed as servlet 111 is accessed, using a URL or an SPI. Such a URL is illustratively in the form of http://host/context/portlet-name. A specialized manifestation of portal context is defined in URL form in order to allow portlet B 113 to be called via the URL. When using an SPI, any arbitrary URL can be created and employed. A suitable SPI is provided in the form of a RequestDispatcher, to be described in greater detail hereinafter.

There are multiple techniques for calling portlets such as portlet B 113. Pursuant to a first technique, invoker SPI 109 of portlet container 115 provides for multiple aggregation of portlets on a page. Illustratively, a caller is provided with flexibility to change the behavior of the portal context. Pursuant to a second technique, URL addressability is employed via a URL. This technique does not allow for aggregation of multiple portlets on a page. Any of two types of URL addressability may be employed, including a RequestDispatcher and a URL entered into a browser.

Invoker SPI 109 of portlet container 115 is only accessible from a servlet such as servlet 111. Invoker SPI 109 of portlet container 115 uses a Java interface available through a ServletContext attribute. Any servlet can call portlets using this Java interface. An example of this interface is as follows:

PortletContainer pc = (PortletContainer)
ServletContext.getAttribute
(“com.ibm.websphere.portletcontainer”);
PorletInvoker invoker = pc.getPortletInvoker(ctx);

Portlets and servlets, including portlet B 113 and servlet 111, can be defined together in one WAR file. However, due to URL addressability considerations and security features (described below), the following restrictions may be applied to servlet and portlet descriptors. First, a portlet and a servlet can never use the same name. Second, a servlet mapping cannot be the same as any /<portletname>/ or /portlet/<portletname>/. These restrictions are validated during application install and, if either or both of these conditions are violated, the WAR file is rejected. URL addressability defines a URL format, such as http://host:port/context/portlet-name/portletwindow. Additional path parameters could, but need not, be utilized to specify version, action, mode, state, render parameters, query parameters, or other parameters as, for example: http://localhost/demo/weather/default/action/mode=edit/state=max. URLs may, but need not, be defined with reference to RFC 2396 of the Public URL Form.

URL addressability preferences are stored in a cookie. The attributes of the cookie are defined as Path, Name, and Value. Path contains context, portlet name, and window ID in the form of /context/portlet/window. As a consequence, these preferences are scoped per portletwindow. Name is a fixed value, such as “PortletPreferenceCookie”. Value is a list of preferences with the following structure:

Preferences = *[ “/” pref-name *[ “=” pref-value] ]
pref-name = *pchar2
pref-value = “#*!0_NULL_0!*#” | *pchar2
pchar2 = unreserved | escaped | “:” | “@” | “&” | “+” | “$” |”,|

URLs are employed in the context of RequestDispatcher as follows. The same URL structure may be adopted as previously discussed in connection with URL addressability. Include is used to call action and render. Forward is not supported. If the URL contains an action, the action is automatically processed. The caller should find out if the URL contains an action by processing the URL. A portlet URL helper may be provided in the form of PortletURLHelper. The caller can control whether or not portlet container 115 should return directly after the action or proceed with the calling render. The caller can set a servlet 111 request attribute with a name ‘com.ibm.websphere.portlet.action’ and value ‘redirect’. Exceptions are wrapped into ServletExceptions.

RequestDispatcher supports a simple aggregation of multiple portlets. In order to ensure that all portlet capabilities are operational, the following functionalities may be provided: URL handling, action handling, portlet preferences, render parameters and, optionally, exception handling. The URL handing functionality operates to allow portlet container 115 to generate correct URLs. Correct URL generation is made possible by passing a template URL into portlet container 115 using a request attribute. The attributes with a name “com.ibm.websphere.portlet.url.prefix”, “suffix”, and “queryparams” describe the URL to a containing JSP. Between prefix and suffix, portlet container 115 will complete a portlet specific URL. An example of this process is as follows:

ServReq.setAttribute(com.ibm.websphere.portlet.url.prefix”,
“http://localhost/ctx/myservlet/”);
ServReq.setAttribute(com.ibm.websphere.portlet.url.suffix”, “/more”);
ServReq.setAttribute(com.ibm.websphere.portlet.url.queryparams”,
“param1=value1&param2=value2”).

The action handling functionality mentioned above operates as follows. In order to call the action method of a portlet, the containing servlet or JSP has to call the portlet with the action before any content is written onto an output stream. In some cases, it is also sufficient to only call action before any other link on the page has been generated, such as in situations where preferences are not stored in cookies. It is recommended to always perform a redirect after calling action. This enables the ability to bookmark, as well as providing functionality for a back button of the web browser to operate, as otherwise these features would not operate.

The interface for portlet preferences are cookies as defined previously. A containing servlet or JSP should consolidate all preferences and store these preferences in the form of structured data. It is recommended to store the consolidated preferences in a cookie as well. Since preferences can only be changed within the action method of a portlet, the cookie can also be set on the not yet committed response. The render parameters of all portlets on at least one page have to be stored for a length of time that extends beyond one request. There are two alternatives to such storage. First, a URL can be employed. However, such a URL would be very long and complex. Errors are possible due to URL length limitations. On the other hand, the URL would permit book marking and back button support. Second, a session can be employed to hold as much information as necessary without limitation. Unfortunately, this second approach will not support book marking and back button functionalities.

A plurality of tags are incorporated into a Java server page (JSP)-compliant page or JSP-compliant page fragment to insert portlet content from a portlet directly onto a page without using an enterprise portal application. The plurality of tags may be provided in the form of a tag library for simple aggregation. The following tags may be provided to allow portlet aggregation from within a JSP: (a) portlet-fw:init, (b) portlet-fw:state, and (c) portlet-fw:insert. Other tags may optionally be used in addition to the three aforementioned tags. Portlet-fw:init is an initialization tag that uses a mandatory attribute of portletURLPrefix=“X”, and possible optional attributes of portletURLSuffix=“Y”, and portletURLQueryParams=“Z”. Portlet-fw:init should be called at the beginning of any JSP. Portlet-fw:state is a state tag that uses a mandatory attribute of URL “X”, and possible optional attributes of mode “Y”, WindowState=“Z”, and more. Portlet-fw:insert is an insertion tag that uses a mandatory attribute of URL=“X”, and possible optional attributes of windowld=“Y”, contentVar=“A”, contentScope=“B” (default: page), titleVar=“C”, titleScope=“D” (default: page), and flush=“true/false” (default: false), and more.

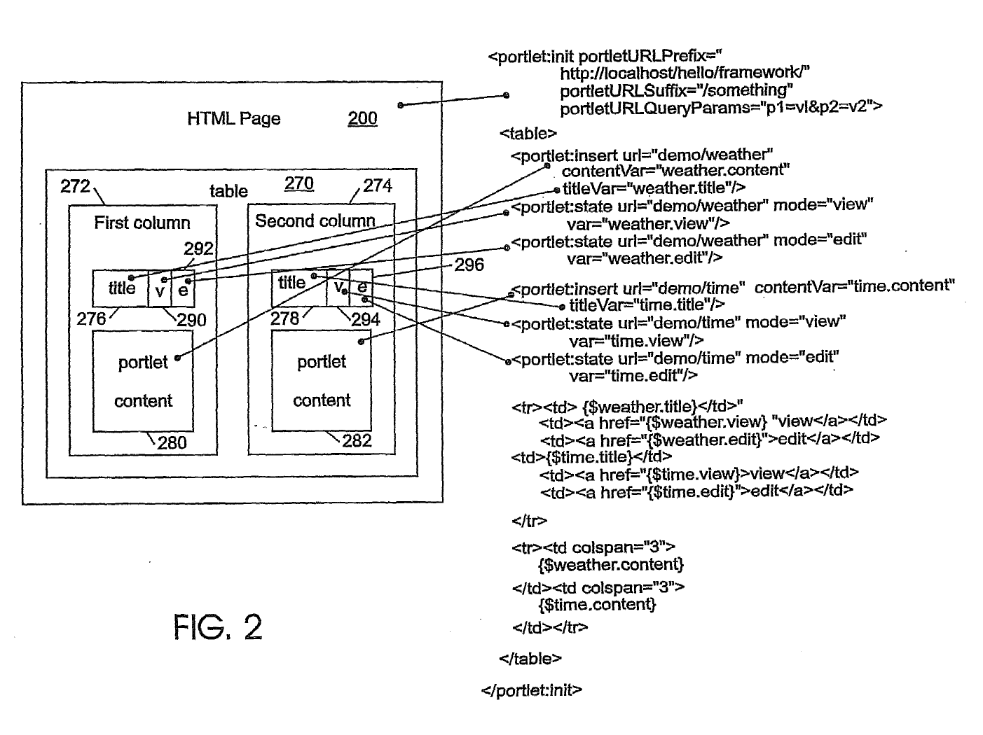

FIG. 2 illustrates one example of an HTML page 200 including tags for use with the apparatus of FIG. 1. HTML page 200 includes a table 270. Table 270 includes a first column 272 and a second column 274. First column 272 includes a title 276, a V field 290, an E field 292, and portlet content 280. Similarly, second column 274 includes a title 278, a V field 294, an E field 296, and portlet content 282. HTML page 200 includes an initialization tag in the form of <portlet:init portletURLprefix=...>. An insertion tag is included in portlet content 280 in the form of <portlet:insert URL=“demo/weather...>. A state tag is included in V field 290 as <portlet:state URL=“demo/weather” mode=“view” var=“weather.view”/>. State tags are also included in E field 292, V field 294 and E field 296.

Assume that a user issues a request to access HTML page 200. A browser URL is http://localhost/hello/framework. An HTTP session is empty. A URL is constructed in the form of: http://localhost/hello/framework/demo/weather/default/ver=1.0/mode=edit/something?p1=v1&p2=v2. The user issues a second request by clicking on a link in a weather portlet. The browser URL is: http://localhost/hello/framework/demo/weather/default/ver=1.0/mode=edit/something?. The HTTP session (URL is parsed in portlet.init): demo/weather/default: mode=edit. The URL in response is: http://localhost/hello/framework/demo/weather/default/ver=1.0/rparam=page=2/something?p1=v1&p2=v2.

Pursuant to a third request, the user clicks on a link in a time portlet. The browser URL is: http://localhost/hello/framework/demo/time/default/ver=1.0/rparam=page=2/something?. The HTTP session (URL is parsed in portlet.init): demo/weather/default: mode=edit, and demo/time/default: rparam=page=2. The URL in response is http://localhost/hello/framework/demo/weather/default/ver=1.0/action=something?. A fourth request is issued when the user clicks on a link in the weather portlet. The browser URL is: http://localhost/hello/framework/demo/time/default/ver=1.0/action=something?. The HTTP session (URL is parsed in portlet.init): demo/weather/default: mode=edit, and demo/time/default: rparam=page=2. An action method of demo/weather is called and a redirect is issued after that.

Invoker SPI 109 (FIG. 1) of portlet container 115 may be employed for action handling. Optionally, servlet filter 107 may be utilized for action handling. Invoker SPI 109 is an interface containing action and render. Action is set in a URL, and an action flag is represented in the URL. After the action has been executed, a redirect is automatically issued to call render. RequestDispatcher may be used for action handling. Include must be used to call action and render. URL format is simply reused to transport all information. Redirect location is set on response.send.Redirect. The calling servlet should check this value. In order to support preferences, the calling servlet needs to access and parse the cookie that is set.

Error and exception handling operates as follows. Invoker SPI 109 of portlet container 115 generates PortletExceptions and PortletContainerExceptions. When called via browser, the exceptions are converted into HTTP error codes. Internal server errors are converted into standard 500-category errors. User errors are converted according to different error codes, such as a wrong URL format error may be converted into a 400-category “Not Acceptable” error. When called via RequestDispatcher, the PortletExceptions and PortletContainerExceptions are wrapped into one or more ServletExceptions. PortletUnavailableExceptions are transformed into ServletUnavailableExceptions. Portlet container 115 logs one or more root causes for the exceptions.

An optional extended portlet deployment descriptor may be used, such as ibm-portlet-ext.xmi. This deployment descriptor is optional and may be used to define Websphere extensions for portlets. The following setting is supported: portletServingEnabled=Boolean [default: true]. This setting defines whether or not a portletServingServlet is created for each portlet.

A portal may be equipped to allow the portal to suppress portlet serving. A portlet serving flag may be turned off pursuant to a default setting. Any of two acceptable options may be employed. First, the default for portlet serving servlet is set to false. During deployment of a portlet application, an additional step is displayed to the user whereby the user can select if this capability should be turned on or off. Second, the default for portlet serving servlet is set to true. The portal would automatically turn off this value during installation and allow an administrator to change the flag in the future if necessary. This would either require an administrator console enhancement or portal administration enhancement.

A portlet only delivers fragment output whereas a servlet normally delivers document output. In order to address portlets like servlets, a default servlet is introduced similar to a FileServingServlet which, for example, is termed a PortletServingServlet. A default document ServletFilter is applied to the PortletServingServlet in order to return the portlet's content inside of a document. Other servlet filters can be applied to enhance this capability. This filter only applies for requests, not for includes or forwards. The servlet is developed to support the URL format of the portlet context. The PortletServingServlet can be disabled in an extended portlet deployment descriptor named ibm-portlet-ext.xmi.

Servlet filter 107 (FIG. 1), also termed a Document Servlet Filter, is used to embed a portlet's content into a document. Additional Document Servlet Filters can be defined through an XML file. As long as no other filter is defined, a default HTML servlet filter is applied. The filter capability is a server feature and thus should be installed into application server 101. Servlet filter 107 cannot change the portal context or URL format. Servlet filter 107 can only call chain.doFilter once. This signifies that server filter 107 needs to handle a situation action and render by including a portlet only once. This can be accomplished via redirect or other means. Servlet filter 107 is responsible for converting a fragment output into a document output. If servlet filter 107 is to support browser caching or dynamic portlet titles, the complete portlet content must be cached. Exception occurrences have to be converted into an HTTP error code of 400 or 500 and logged out.

From time to time, there might be situations where multiple servlet filters 107 are called and it is not known if a fragment was already converted into a document. Therefore, a new request attribute is defined with the name ‘com.ibm.websphere.portlet.filter’. This attribute needs to be set to the value ‘document’ as soon as one filter starts converting the fragment into a document. This allows servlet filter 107 to check for a situation where multiple filters may be engaged in converting a document, so as to avoid invalid markup.

A new XML structure is defined that can be used to add new document servlet filters 107. The file named portlet-document-filter-config.xml resieds in a META-INF/directory of any JAR file in <WAS-HOME>/lib or a shared library bound to a server. An illustrative example of a suitable XML file is as follows:

<?xml version=”1.0” encoding=”UTF-8”?>
<portlet-document-filter-config
xmlns:xsi=”http://www.w3.org/2001/XMLSchema-instance”
xsi:schemaLocation=”http”//www.ibm.com/xml/ns/
PortletDocumentFilterConfig.
xsd”>
<portlet-document-filter>
<har-name>myJAR.jar</jar-name>
<class-name>com.ibm.wea.wml.PortletDocumentFilter</class-name>
<order>1000</order>
</portlet-document-filter>
</portlet-document-filter-config>

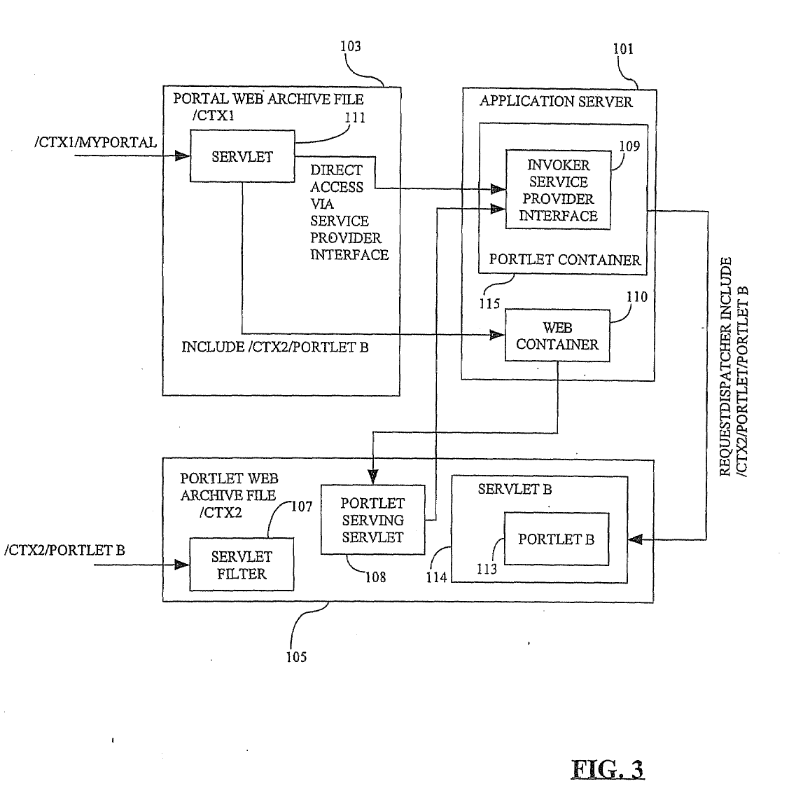

FIG. 3 is a block diagram illustrating a second example of an apparatus for insertion of JSR 168 portlet content into J2EE Java server page. Many of the elements shown in FIG. 3 were previously described in conjunction with FIG. 1. However, in the configuration of FIG. 3, a web container 110 is included in application server 101. Portlet B 113 is included within a wrapper servlet termed servlet B 114. Portlet WAR file 105 includes a portlet serving servlet 108. One wrapper servlet (servlet B 114) and one portlet serving servlet 108 are employed per portlet. Portlet serving servlet 108 handles exceptions by wrapping PortletExceptions and PortletContainerExceptions into ServletExceptions. PortletUnavailableExceptions are transformed into ServletUnavailableExceptions. Portlet container 115 (FIG. 3) logs the root cause or causes for these exceptions. If default document servlet filter 107 is used to handle exceptions, these exceptions are converted into HTTP error code 400 or 500.

An optional web server plug-in may be employed. Portlet mapping is not part of web.xml and thus is not automatically passed on to the web server plug-in. A mechanism should be provided to pass this information on to the web server plug-in. The web server plug-in includes generation code that obtains a reference to a portlet deployment descriptor, illustratively in WCCM Model form. The code also checks to see if PortletServingEnabled is turned on. Depending on whether PortletServingEnabled is turned on, a corresponding URL pattern is added for each portlet /<portlet-name>/.

Portlet container 115 (FIGS. 1 and 3) supports optional custom modes and states. These custom modes and states may involve Invoker SPI 109, URL addressability, and MBeans. Dynamic portlet titles may, but need not, be employed. This feature allows a portal to retrieve a title that is dynamically set by a portlet. A new portlet container service is introduced called DynamicTitleService. This service needs to be implemented by a portal to support this feature. Portlet Serving Servlet 108 (FIG. 3) will also support this feature, and will provide a dynamic title as requested pursuant to a request attribute (javax.portlet.title).

A model for portlet container 115 is stored in server.xml of application server 101 (FIGS. 1 and 3). The model contains only two settings: portletFragmentCaching=boolean [Default: false], defining whether or not a dynacache (described later) is used to cache portlets, and portletServingEnabled=Boolean [Default: true], which defines if a portlet serving is enabled for each application running in application server 101. A portletServingEnabled setting on the application level takes precedence over the portletServingEnabled setting of portlet container 115.

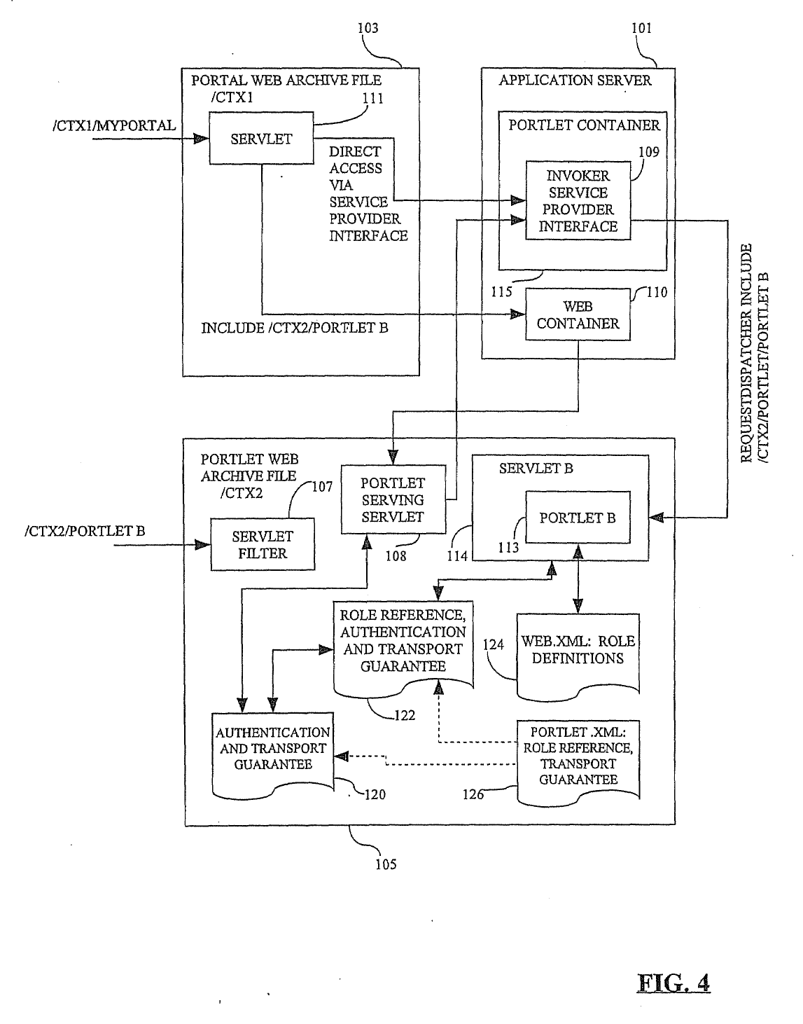

FIG. 4 is a block diagram illustrating one example of providing security features for use with the apparatus of FIG. 3. Many of the elements shown in FIG. 4 were previously described in conjunction with FIG. 3. However, in the configuration of FIG. 4, a web.xml role definitions 124 is associated with portlet B 113. A role reference, authentication, and transport guarantee 122 is associated with servlet B 114, and an authentication and transport guarantee 120 is associated with portlet serving servlet 108. Role reference, authentication, and transport guarantee 122 and authentication and transport guarantee 120 are associated with a portlet.xml role reference and transport guarantee 126. Authentication and transport guarantee 120, role reference, authentication, and transport guarantee 122, web.xml role definitions 124, and portlet.xml role reference and transport guarantee 126 support various security features as follows. Invoker SPI 109 is provided with programmatic security. Declarative security is not supported but can be implemented by the calling servlet or portal. RequestDispatcher includes programmatic security. Delcarative security is not supported but can be implemented by the calling servlet or portal. A URL in a browser is provided with programmatic security as well as declarative security, including authentication.

Since a portlet can be addressed directly via a URL, the URL can be leveraged based upon an authentication mechanism provided by web.xml of web.xml role definitions 124. As a result, a directly accessible portlet can be secured from direct access. If one defines a TransportGuarantee in web.xml role definitions 124 as well as in portlet.xml role references and transport guarantee 126 using the same name or mapping, the value of portlet.xml wins, meaning that the web.xml value is overwritten. For example, a portlet with the name “HelloWorld” is defined in portlet.xml, role reference and transport guarantee 126. This portlet can be secured by defining an authentication constraint with the URL mapping ‘/HelloWorld/*’ in web.xml role definitions 124. In this manner, a user would be challenged if they attempted to access the portlet.

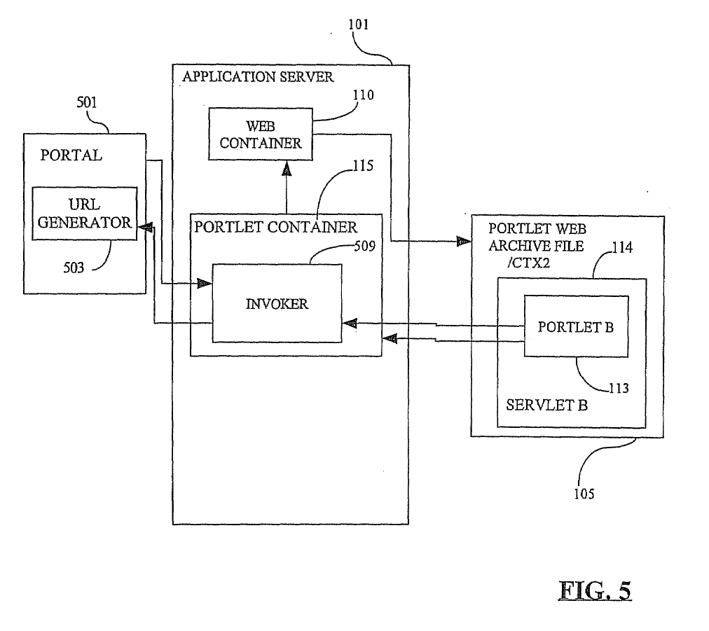

FIG. 5 is a block diagram illustrating a first example of an apparatus for processing portlet fragments to provide insertion of JSR 168 portlet content into a J2EE Java server page. Many of the elements shown in FIG. 5 were previously described in conjunction with FIG. 1. However, in the configuration of FIG. 5, a web container 110 is included in application server 101. Portlet container 115 includes an invoker 509, and portlet B 113 is wrapped within a servlet B 114. A portal 501 that includes a URL generator 503 is in communication with invoker 509. In operation, portal 501 calls invoker 509 of portlet container 115 to render a portlet. Portlet container 115 calls the portlet via web container 110. The portlet creates a URL by using the portlet API. Portlet container 115 then queries a PortalsURLGeneration component of URL generator 503.

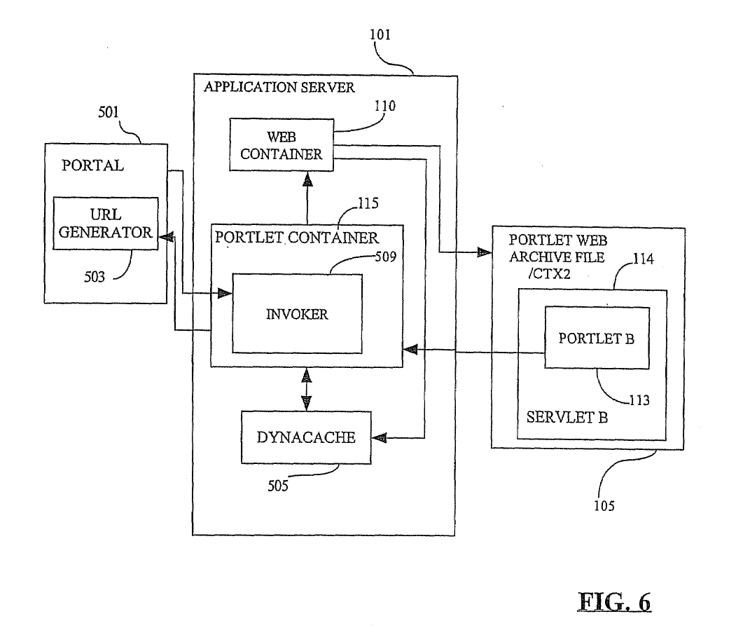

FIG. 6 is a block diagram illustrating a second example of an apparatus for processing portlet fragments to provide insertion of JSR 168 portlet content into J2EE Java server page. Many of the elements shown in FIG. 6 were previously described in conjunction with FIG. 5. However, in the configuration of FIG. 6, a dynacache 505 is included in application server 110. Dynacache 505 may be employed in situations where it is desired to cache only the render method, but not the action method. Invalidation may be performed after the action has been called. The target portlet of a current request is invalidated for an action link as well as for a render link.

A portlet fragment can contain a state in a response that does not belong to this fragment. When this state changes, the cached fragment needs to retain its validity. One solution is to use a DynamicContentProvider of dynacache 505 to solve the problem of not having cacheable content in the fragment. The problem may be introduced due to a state describing parts outside of the cached fragment which are part of the portlet URL. The cacheable data of the portlet URL are set as request attributes, setting a callback with the DynamicContentProvider. Portlet URL creation is not triggered directly, but rather through callback, when a cache hit occurs. Therefore, portlet container 115 (FIGS. 5 and 6) needs to ascertain whether or not a cache hit occurred.

Referring now to FIG. 6, portal 501 issues a first request to portlet container 115 to render a portlet. Portlet container 115 calls the portlet via web container 110. The portlet creates a URL by using the portlet API. Portlet container 115 writes the state of the currently to be created portlet URL into request attributes and uses dynacache 505 to set a callback. In a second request, portal 501 calls portlet container 115 to render the portlet. Portlet container 115 tried to call render of the portlet, but web container 110 and/or dynacache 505 recognize that the portlet is cached. Next, dynacache 505 processes the cache entry, deserializing the request attributes and calling the callback. Portlet container 115 then queries a Portals URL Generation component of URL generator 503. A URL containing state (render parameters) of all portlets on a page is not cached in the portlet fragment.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for inserting portlet content into a Java 2 Platform Enterprise Edition (J2EE) server page, the method comprising:
incorporating a plurality of tags into a Java server page (JSP) or JSP-compliant page fragment to insert portlet content from a portlet onto the page or page fragment without using an enterprise portal application, each of the plurality of tags conforming to J2EE and JSP, the portlet content conforming to Java Specification Request (JSR) 168, and
rendering the portlet content using the plurality of tags such that no change is introduced to the portlet itself,
wherein the tags include an initialization tag setting forth a uniform resource locator (URL) prefix, an insertion tag setting forth a first URL, and a state tag setting forth a second URL, such that the first URL and the second URL may, but need not, be identical.

2. The method of claim 1 further including the step of invoking a portlet on a JSP or JSP-compliant page fragment using a standard web container hypertext transfer protocol (HTTP) request.

3. The method of claim 2 further including the step of displaying portlet content from the portlet using a web browser, such that an enterprise portal application is not required to display the portlet content.

4. The method of claim 1 wherein incorporating a plurality of tags is performed using an editing mechanism.

5. The method of claim 4 wherein the editing mechanism processes portlet fragments to provide insertion of JSR 168 portlet content into the J2EE Java server page.

6. The method of claim 5 further including storing a plurality of portlet fragments on a cache.

7. An apparatus for inserting portlet content into a Java 2 Platform Enterprise Edition (J2EE) server page, the apparatus including:
an editing mechanism for incorporating a plurality of tags into a Java server page (JSP) or JSP-compliant page fragment to insert portlet content from a portlet onto the page or page fragment without using an enterprise portal application, each of the plurality of tags conforming to J2EE and JSP, the portlet content conforming to Java Specification Request (JSR) 168, and
a rendering mechanism capable of rendering the portlet content using the plurality of tags such that no change is introduced to the portlet itself;
wherein the tags include an initialization tag setting forth a uniform resource locator (URL) prefix, an insertion tag setting forth a first URL, and a state tag setting forth a second URL, such that the first URL and the second URL may, but need not, be identical.

8. The apparatus of claim 7 further including an invocation mechanism for invoking a portlet on a JSP or JSP-compliant page fragment using a standard web container hypertext transfer protocol (HTTP) request.

9. The apparatus of claim 8 further including a display mechanism for displaying portlet content from the portlet using a web browser, such that an enterprise portal application is not required to display the portlet content.

10. The apparatus of claim 7 wherein the editing mechanism processes portlet fragments to provide insertion of JSR 168 portlet content into the J2EE Java server page.

11. The apparatus of claim 10 wherein the editing mechanism includes a cache for storing a plurality of portlet fragments.
